(19) United States
(12) Patent Application Publication
(10) Pub. No.: US 2016/0003016 A1
(43) Pub. Date: Jan. 7, 2016

(54) ESP System Having Carbon Nanotube Components

(71) Applicant: Baker Hughes Incorporated, Houston, TX (US)

(72) Inventors: Tina H. Chang, Tulsa, OK (US); Peter F. Lawson, Tulsa, OK (US); David W. Livingston, Claremore, OK (US); Sean A. Cain, Owasso, OK (US)

(21) Appl. No.: 14/790,747

(22) Filed: Jul. 2, 2015

Related U.S. Application Data
(60) Provisional application No. 62/020,926, filed on Jul. 3, 2014.

(51) Int. Cl. E21B 43/12; H02K 17/02; H02K 5/22; H02K 3/02; H02K 17/16

(52) U.S. Cl. CPC E21B 43/128; H02K 3/02; H02K 17/165; H02K 5/225; H02K 17/02

(57) ABSTRACT

An electric submersible pump (ESP) system that is installed in a well to lift fluids out of the well. In one embodiment, the system includes an electric drive positioned at the surface of a well, an ESP positioned downhole in the well, and a cable coupled to carry power from the drive to the ESP. The ESP has a motor that may be either a rotary or linear motor. The stator has magnet coils that may be formed by carbon nanotube conductors. In an inductive rotary motor, carbon nanotube conductors to form the rotor bars and/or conductive end plates of the rotor. The power cable coupling the electric drive to the ESP motor may use carbon nanotube conductors to carry power to the motor, and may also use carbon nanotube strength members to carry the weight of the cable and ESP.

### CROSS-REFERENCE TO RELATED APPLICATIONS

This application claims the benefit of U.S. Provisional Patent Application 62/020,926, filed Jul. 3, 2014, which is incorporated by reference as if set forth herein in its entirety.

### BACKGROUND

1. Field of the Invention

The invention relates generally to oil production, and more particularly to electric submersible pump (ESP) systems that utilize components which are made with carbon nanotube materials

2. Related Art

Oil is typically extracted from geological formations through the wells that extend far below the earth's surface. Often, the naturally existing pressure in the wells is insufficient to force the oil out of the wells. In this case, artificial lift systems such as ESP's are used to extract the oil from the wells. ESP's are also commonly utilized when operators want to increase the flow rate of the fluid being extracted, such as when the water cut (percentage of water versus oil) increases.

An ESP system includes a pump and a motor that are lowered into a producing region of the well. Typically, the pump is connected to a conduit (e.g., a tubing string) through which oil is pumped to the surface. This conduit is normally used to lower the ESP system into the well, and to retrieve the ESP from the well. A power source at the surface of the well is connected to the ESP motor via a power cable that is connected to the conduit. For example, the power cable may be banded to the exterior of the conduit. The power cable in this type of system normally does not bear any of the weight of the ESP.

Sometimes a well operator wishes to use a cable-deployed ESP system. Conventional power cables, however, typically are not designed to support the weight of an ESP system. In fact, conventional power cables do not normally have the tensile strength to support even their own weight in lengths over about 1000 feet.

Conventional power cables for downhole equipment typically use annealed copper conductors which have excellent electrical conductivity, but very low tensile yield strength. As a result, prior art cables that have been designed for cable-deployed systems have required load-bearing structures within the cables that are separate from the electrical conductors, and that are capable of supporting the immense weight of the cable and ESP system.

### SUMMARY OF THE INVENTION

This disclosure is directed to ESP systems that solve one or more of the problems discussed above. In one embodiment, an ESP system that is installed in a well includes an electric drive positioned at the surface of a well, an ESP positioned downhole in the well, and a cable coupled to carry power from the drive to the ESP. Various components within the system may be formed using carbon nanotubes in order to provide improved performance over conventional systems. In one embodiment, the ESP motor may use carbon nanotube members in place of conventional copper wires to form the magnetic coils of the stator. In another embodiment, conductors within the motor's rotor, such as conductive rotor bars and end plates, may be formed using carbon nanotubes. The power cable may also use carbon nanotube materials to form the power conductors, tensile strength members or protective armor of the cable. The use of electrically carbon nanotube components in place of conventional copper conductors may provide increased electrical conductivity, increased thermal conductivity and reduced weight, each of which can improve system performance. The carbon nanotube conductors can also provide increased structural strength in comparison to copper conductors. Carbon nanotube materials that are used as strength members can provide increased strength and reduced weight in comparison to conventional materials such as steel.

Numerous alternative embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating an exemplary artificial lift system in accordance with one embodiment.

FIG. 2 is a diagram illustrating the structure of an exemplary motor suitable for use in an electric submersible pump system.

FIG. 3 is a diagram illustrating the structure of an exemplary “squirrel-cage” type of rotor.

FIG. 4 is a diagram illustrating the structure of an exemplary stator.

FIGS. 5A-5F are diagrams illustrating several embodiments of power cables that utilize carbon nanotube components.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as described herein. Further, the drawings may not be to scale, and may exaggerate one or more components in order to facilitate an understanding of the various features described herein.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

Generally speaking, the present systems and methods are directed to ESP systems and subsystems in which conventional components are replaced with carbon nanotube components to provide advantages such as increased conductivity and strength, and decreased weight. This new combination of components results in reduced system weight, as well as cables that have sufficient strength to support both their own weight and the weight of the ESP.

Embodiments of the present invention may reduce or eliminate some of the problems of ESP systems as described above by utilizing components that are constructed using carbon nanotube materials. These materials can provide a number of advantages over conventional materials, including increased electrical conductivity, increased strength, increased thermal conductivity, higher power density, decreased weight, decreased size and resistance to corrosion. The carbon nanotube components may include electrically conductive rotor bars, stator windings, power cable conductors, motor leads, connector components and the like. The carbon nanotube components in an ESP system may provide sufficient increases in strength and reductions in weight in comparison to conventional systems to enable the system to be cable-deployed.

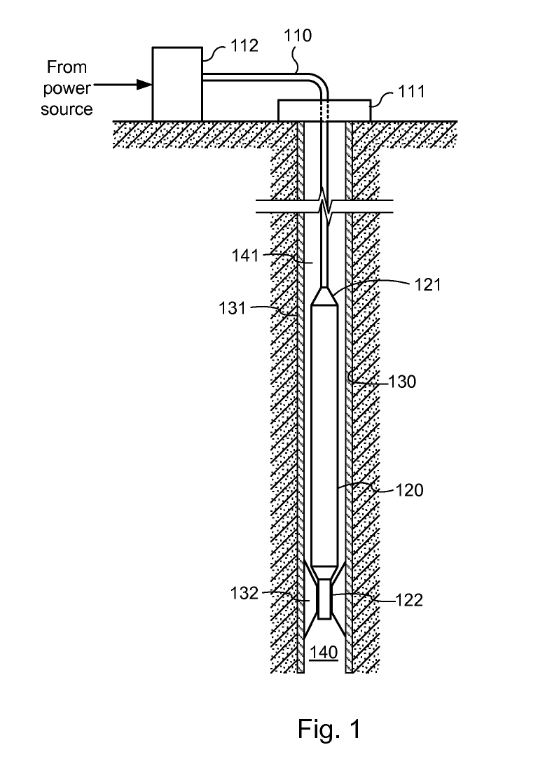

Referring to FIG. 1, a diagram illustrating an exemplary artificial lift system in accordance with one embodiment of the present invention is shown. A wellbore 130 is drilled into an oil-bearing geological structure and a casing 131 is installed in the wellbore. The casing may be perforated in a producing zone of the well to allow oil to flow from the formation into the well. In this example, a landing nipple 132 is installed at the lower end of the well. The landing nipple separates a producing zone 140 from a non-producing zone above it.

A cable-deployed ESP 120 is positioned in the wellbore. The ESP is connected to the lower end of a power cable 110 by a lower coupling 121. Power cable 110 couples the ESP to a drive system 112. The drive system receives power from a source such as an external electrical power grid and converts the power to a form that is suitable to drive the ESP. Typically, the drive system is a variable speed drive that provides three-phase power at a variable voltage, and is thereby used to control the speed of the ESP's motor.

Power cable 110 is also configured to suspend the ESP as it is installed into the well or retrieved from the well. A pothead or other type of coupling device (121) provides a means to both electrically couple the leads of the ESP motor to the electrical conductors of the cable and physically secure the ESP to these same conductors. In one embodiment, the conductors of the cable actually support the weight of the ESP when it is suspended in the well. In this case, the upper end of the power cable will have an upper coupling that is secured to a cable hanger 111. Cable hanger 111 supports the weight of the suspended cable and ESP.

When the ESP is installed in the well, the ESP (suspended by the power cable) is lowered into the well. When the ESP reaches landing nipple 132, a stinger 122 on the bottom of the ESP stabs into landing nipple 132, sealing the producing zone below the landing nipple from the upper portion of the well. The drive system can then provide power to the ESP via the cable to drive the ESP's motor. The motor drives the pump, which draws fluid from producing zone 140, through the pump and into the annulus 141 between the ESP/cable and the casing.

As noted above, various components of the ESP system may utilize parts made from carbon nanotube materials to reduce the weight of the system, while increasing their performance with respect to the strength, conductivity and other characteristics. In one embodiment, the ESP system may utilize carbon nanotube components in the rotor and stator of the ESP motor, as well as in the power cable, motor leads, connectors, and other electrical components that couple the drive at the surface of the well to the ESP that is downhole in the well.

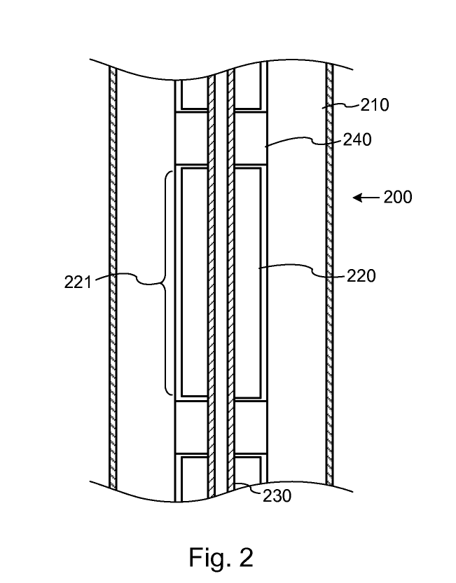

Referring to FIG. 2, a diagram illustrating the structure of an exemplary electric induction motor suitable for use in an electric submersible pump system is shown. As depicted in this figure, motor 200 has a stator 210 and a rotor 220. Stator 210 is generally cylindrical, with a coaxial bore that runs through it. Rotor 220 is coaxially positioned within the bore of stator 210. Rotor 220 is attached to a shaft 230 that is coaxial with the rotor and stator 210. In this example, rotor 220 includes multiple sections (e.g., 221), where bearings (e.g., 240) are positioned at the ends of each section. The bearings support shaft 230, and consequently rotor 220, within the bore of stator 210 and allow the rotor and shaft to rotate within the stator.

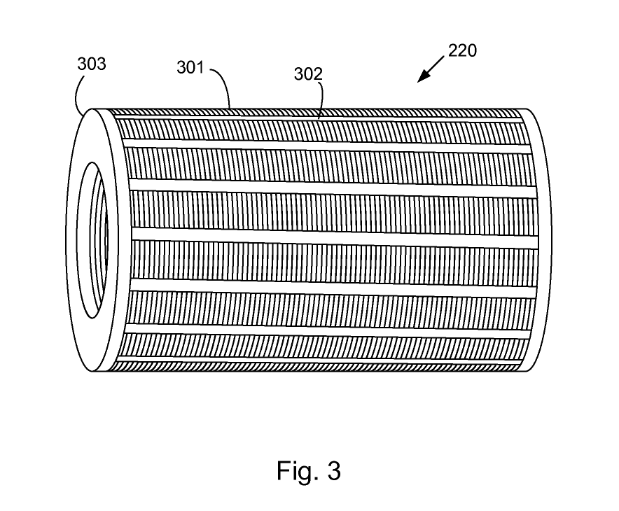

Referring to FIG. 3, a diagram illustrating the structure of an exemplary “squirrel-cage” type of rotor is shown. Rotor 220 has a set of identical laminations (e.g., 301) that are stacked together to form a generally cylindrical core. The shaft of the motor is positioned through the central bore of the rotor. A plurality of conductive rotor bars (e.g., 302) are positioned around the periphery of the core, and the ends of the rotor bars are electrically coupled to conductive end plates (e.g., 303) so that current can flow through each of them. Typically, the rotor bars are not quite parallel to the axis of the cylinder, but are instead slightly skewed. The configuration of the rotor bars and end plates give the design its characteristic squirrel-cage appearance.

In this embodiment, the rotor bars are manufactured using a carbon nanotube material. The end plates may also be made from the carbon nanotube material. The carbon nanotube material has a higher electrical conductivity than the annealed copper that is commonly used to form the rotor bars, so the rotor will have lower resistive losses than conventional rotors. This will result in higher power density and higher operating speed than conventional rotors. The increased conductivity and corresponding decreased resistive losses in the carbon nanotube material result in lower heat generation. The carbon nanotube material also provides better heat dissipation than copper. These heat generation and dissipation characteristics allow the motor to operate at cooler temperatures for a given load, which in turn results in a longer operational life for the motor. In addition to the improved electrical and heat characteristics provided by the carbon nanotube material, this material has greater strength than copper. Since the rotor bars are strength members that undergo stresses from manufacturing processes and operation of the motor, the increased strength of the carbon nanotube rotor bars can provide improved performance due in the motor.

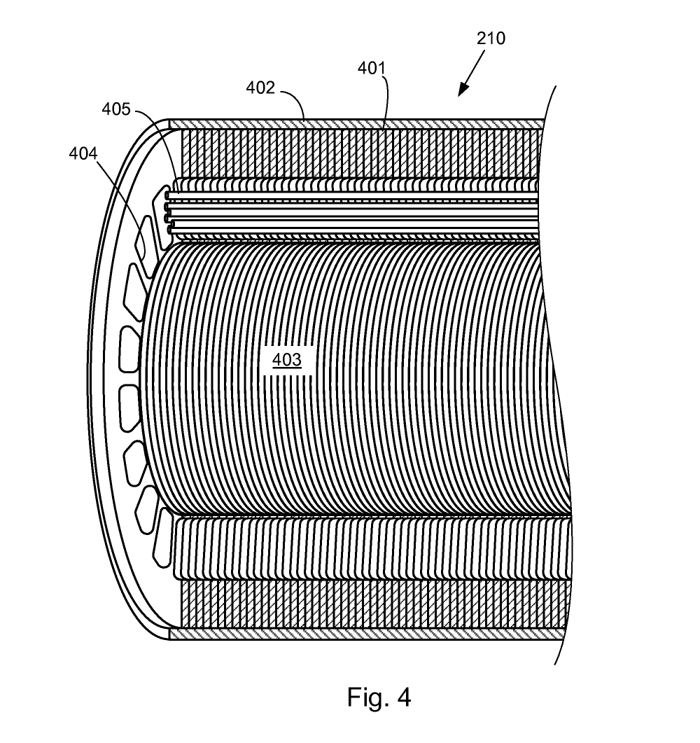

In the assembled motor, the rotor is positioned so that it can rotate within the central bore of the stator. Referring to FIG. 4, a diagram illustrating the structure of an exemplary stator is shown. FIG. 4 depicts a cross-section of the stator through its longitudinal axis. It can be seen that the core of the stator, similar to the core of the rotor, is formed by stacking a set of identical laminations (e.g., 401) together. The stacked laminations are pressed into a stator housing 402. Typically, the stack of laminations is held in place in the housing by securing the lamination at each end of the stack to the housing (for example, by welding the lamination to the housing or placing a locking ring at the end of the stack and welding the ring to the housing).

The stator core has a central bore (403) within which the rotor is positioned. The stator core also has a plurality of slots (e.g., 404) that accommodate the windings of the stator. In the exemplary structure of FIG. 4, the stator has a closed-slot design, so the windings are formed by threading magnet wires (e.g., 405) through the slots. (For purposes of simplicity and clarity, wires are only shown in one of the slots—the wires are actually threaded through all of the slots in the assembled stator.) Conventionally, the windings are copper wires, but in this embodiment, conductors made of carbon nanotubes are used instead of conventional copper magnet wires. The carbon nanotube magnet wires have a greater conductivity than the copper wires, so the stator can be designed to use comparably sized carbon nanotube wires that carry more current than conventional copper wires. The stator using the carbon nanotube wires can therefore have increased horsepower as compared to conventional stators.

As an alternative to using carbon nanotube magnet wires that are comparably sized with conventional copper wires, the stator can use smaller carbon nanotube wires that carry a comparable amount of current. The stator could therefore provide the same amount of horsepower in a smaller size (e.g., smaller outer diameter). It should be noted that the size of the magnet wire in the stator is one of the factors that has the most impact on the size and weight of the motor. Since the motor is typically the component of an ESP system that has the largest outer diameter, reducing the outer diameter of the motor through the use of carbon nanotube magnet wires may allow the ESP system to be installed in deviated wells and smaller-diameter casings.

The use of carbon nanotube magnet wires may provide other benefits In addition to increasing the conductivity of the windings. As noted above, carbon nanotube material has greater thermal conductivity than copper, so the carbon nanotube windings of the stator will dissipate heat more efficiently than conventional copper windings. Because heat from the stator windings is more rapidly dissipated, the ESP motor will run cooler than a conventional motor at the same load, which will result in a longer run life for the motor. Carbon nanotube wires are also stronger than copper wires and are less likely to be damaged during installation in the stator.

ESP motors that have rotors and stators with carbon nanotube components materials may therefore be more efficient (electrically and thermally), smaller, lighter and more powerful than conventional motors that use copper conductors. The cables that carry power from drives at the surface of wells to these motors can also benefit from the use of carbon nanotube materials. The power cables can utilize carbon nanotube conductors that can increase the efficiency and reduce the weight of the cables, as well as carbon nanotube strength members that can enable the cables to support the weight of the system and allow cable-deployment of the system.

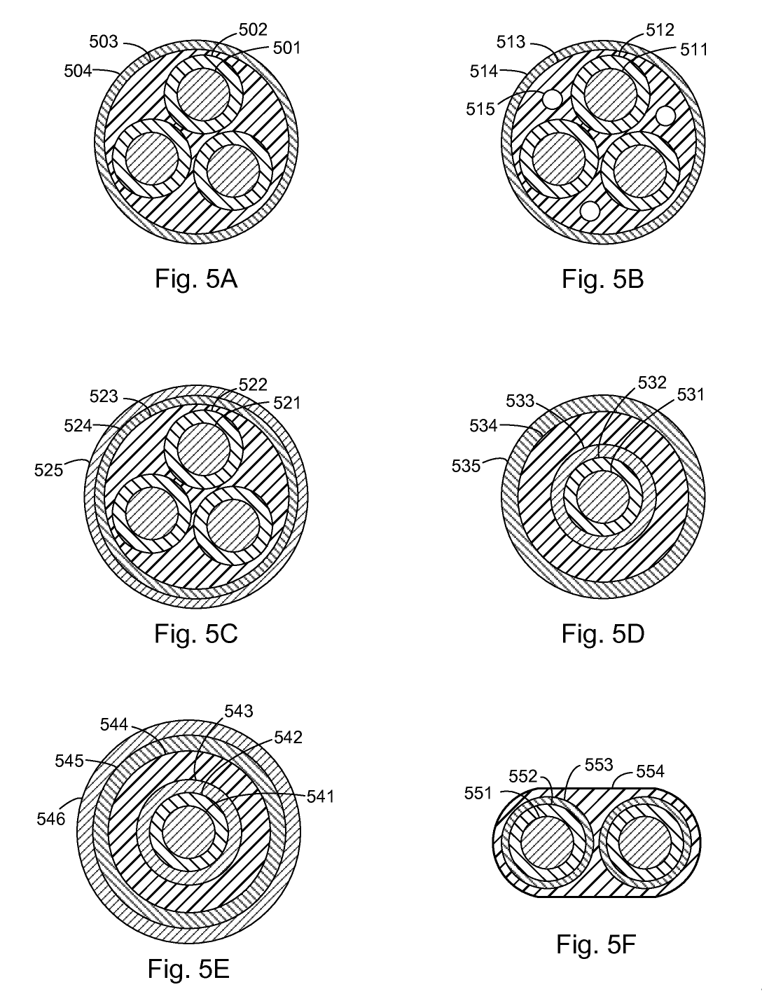

Referring to FIGS. 5A-5F, several embodiments of power cables that utilize carbon nanotube components are illustrated. These figures show cross-sectional views of the different embodiments of the power cables. Each of the embodiments utilizes one or more carbon nanotube conductors to carry electrical power from an electric drive (e.g., a variable speed drive) to an ESP or other downhole equipment. The embodiments illustrated in these figures are suitable for use in cable-deployed systems, and can support the weight of these systems.

Referring to FIG. 5A, the structure of a three-conductor cable suitable for carrying three-phase power to an ESP is illustrated. In this embodiment, three conductors (e.g., 501) are made of a carbon nanotube material. Each of the conductors has an outer layer of electrical insulation (e.g., 502). Each of the three insulated carbon nanotube conductors is positioned next to the other two, and the insulated conductors are encapsulated in an elastomeric jacket 503. A carbon fiber braid or steel braid 504 surrounds the elastomeric jacket to help protect the elastomeric jacket and conductors, and thereby prevent them from being damaged. A layer of protective armor may alternatively be used to prevent the cable from being damaged in the well.

Referring to FIG. 5B, the structure of an alternative round, three-conductor cable is illustrated. In this embodiment, three conductors (e.g., 511) made of a carbon nanotube material are provided. Each of the conductors has a layer of electrical insulation (e.g., 512) around the carbon nanotube conductor. The three insulated carbon nanotube conductors are positioned adjacent to each other to form a round cable. In this embodiment, three strength members (e.g., 515) are positioned next to the insulated conductors, near their outer periphery. The strength members may be, for example, steel or carbon fiber wires. These strength members are provided to give the cable additional tensile strength and to allow the cable to support more weight (e.g., in a cable-deployed system). The insulated conductors and the strength members are all encapsulated in an elastomeric jacket 513, and a carbon fiber braid or steel braid 514 is placed around the elastomeric jacket to protect the cable from being damaged.

Referring to FIG. 5C, the structure of another alternative round, three-conductor cable is illustrated. In this embodiment, three carbon nanotube conductors (e.g., 521) are provided, each of which has a layer of electrical insulation (e.g., 522). The three insulated carbon nanotube conductors are positioned adjacent to each other in a round-cable configuration. The insulated conductors are encapsulated in an elastomeric jacket 523. A carbon fiber braid or steel braid 524 is formed around the elastomeric jacket. This assembly is installed within coiled tubing 525. The coiled tubing protects the power cable and provides additional tensile strength which enables the assembly to support an ESP.

Each of the embodiments of FIGS. 5A-5C includes three separate carbon nanotube conductors, and is suitable for use in carrying three-phase AC power from an electric drive at the surface of a well to an ESP or other electric equipment downhole in the well. The embodiments of FIGS. 5D-5F are two-conductor cables that can be used to carry DC power to downhole equipment.

Referring to FIG. 5D, the structure of a round, two-conductor cable is illustrated. In this embodiment, an inner carbon nanotube conductor 531 is formed inside a second carbon nanotube conductor 533. A layer of electrical insulation 532 is formed between the two carbon nanotube conductors. An elastomeric jacket 534 is formed around the second, outer conductor 533. The elastomeric jacket may serve as an electrical insulator in this embodiment, and in the other embodiments as well. A carbon fiber braid or steel braid 535 is formed around the elastomeric jacket to provide some protection for the other components of the cable, and potentially to provide some tensile strength to the assembly.

Referring to FIG. 5E, the structure of an alternative two-conductor DC cable is illustrated. In this embodiment, similar to the embodiment of FIG. 5D, an inner carbon nanotube conductor 541 is positioned coaxially within a second carbon nanotube conductor 543. A layer of electrical insulation 542 is formed between the two carbon nanotube conductors, and an elastomeric jacket 544 is formed around outer conductor 543. A carbon fiber or steel braid 545 is formed around the elastomeric jacket. This assembly is installed within coiled tubing 546. The coiled tubing protects the power cable and provides additional tensile strength which helps enable the assembly to support an ESP.

Referring to FIG. 5F, the structure of another alternative two-conductor DC cable is illustrated. In this embodiment, the cable has a flat, rather than coaxial configuration. Two carbon nanotube conductors (e.g., 551), each having a layer of electrical insulation (e.g., 552) are provided. Each of the insulated conductors has a carbon fiber or steel braid around it. The two conductors are positioned side-by-side, and they are encapsulated in an elastomeric jacket 554.

Just as carbon nanotube materials may be used to form the conductors of the power cables, they may be used to form other components that are used to transfer power to downhole ESP equipment, such as motor lead cables, connectors, penetrators, etc. When used in place of conventional copper conductors, carbon nanotube conductors provide improved conductivity, reduced weight, improved corrosion resistance and increased strength, as compared to the conventional conductors.

Carbon nanotube conductors weigh approximately one-sixth as much as copper conductors of the same size. As a result of using carbon nanotube conductors in the rotor, stator, power cable, motor leads, connectors, etc., the weight of the ESP system can be substantially reduced. Improved conductivity also provides a reduced voltage drop and allows for smaller conductors to be used to achieve a given electrical rating and to meet motor voltage requirements. This would in turn reduce the overall size of the power cable. The reduced weight of the carbon nanotube materials may allow cable-deployed ESP systems to be used in longer/deeper applications. The reduced weight of the system also improves the manufacturability and facilitates the installation of the system. Reducing the size of the power cable also reduces the risk of damage during installation of the system.

The improved conductivity and lower resistance of carbon nanotube conductors, as compared to conventional copper conductors, also results in less heat generation in the cable and motor. Because carbon nanotube materials have better thermal conductivity than copper, the heat that is generated in the system is more rapidly dissipated than in systems that use conventional copper conductors. The improved thermal efficiency of carbon nanotube conductors increases the current rating of the cable and improves the reliability and run life of the cable and motor.

Another benefit of using carbon nanotube conductors in power cables and motor leads is improved corrosion resistance, particularly to H₂S. Conventional power cables often have a lead jacket that protects the copper conductors in the cables from the H₂S that is present in sour wells. When carbon nanotube conductors are used in place of copper conductors, this lead jacket is no longer necessary. The elimination of the lead jacket substantially reduces the weight of the cables, which makes it easier to install the cables, and allows cable deployment in deeper wells. The elimination of the lead jacket also improves the manufacturability of the cables, as the cost of material and complexity of the manufacturing process are reduced. Elimination of the lead jacket also eliminates health, safety and environmental issues related to handling lead in the manufacturing, installation and disposal of the final product.

Yet another advantage of using carbon nanotube conductors is their increased strength in comparison to copper conductors. Manufacturing processes typically must be controlled to prevent drawdown of the copper size, which results in scrap. Carbon nanotube conductors do not pose this problem. In regard to installation, the breaking strength of the cable is primarily tied to the strength of the conductor so, by increasing the strength of the conductors, the cable is able to carry a much greater load without damage. This improves the overall performance and reliability of the cable.

The components described above can be combined to provide the advantages of carbon nanotube materials in a cable-deployed ESP system. The use of carbon nanotube conductors in the form of rotor bars, stator windings, power cable conductors, motor lead extension conductors and the like provide significant weight and performance advantages over ESP systems that use conventional construction. This new combination of components enables the construction of cables that have sufficient strength to support both their own weight and the weight of the ESP, and thereby enables cable deployment of these systems to depths that were not previously possible, while also providing improved performance in comparison to conventional systems.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the described embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the descriptions herein.

What is claimed is:

1. An electric submersible pump (ESP) system comprising:
an electric drive positioned at the surface of a well;
an electric submersible pump (ESP) positioned downhole in the well;
a cable coupled between the electric drive and the ESP, wherein the cable carries power from the drive to the ESP;
wherein the ESP has a motor that includes a stator, the stator having one or more magnet coils, wherein at least a portion of the one or more magnet coils is formed by carbon nanotube conductors.

2. The ESP system of claim 1, wherein the ESP motor comprises an induction motor that has a rotor wherein the rotor includes one or more carbon nanotube conductors.

3. The ESP system of claim 2, wherein the rotor comprises a squirrel-cage type rotor and wherein the carbon nanotube conductors comprise one or more rotor bars of the rotor.

4. The ESP system of claim 3, wherein the carbon nanotube conductors further comprise one or more conductive end plates of the rotor, wherein the end plates electrically couple the rotor bars to each other.

5. The ESP system of claim 1, wherein the cable includes one or more carbon nanotube conductors that carry the power from the drive to the ESP.

6. The ESP system of claim 5, wherein the cable contains no copper conductors and has no lead protective jacket.

7. The ESP system of claim 1, wherein the cable includes one or more carbon nanotube strength members, wherein the strength members support the weight of the cable and the ESP.

8. The ESP system of claim 1, wherein the carbon nanotube conductors have a conductivity that is greater than a conductivity of annealed copper.

9. An apparatus comprising:
an induction motor, wherein the induction motor has a stator and a rotor
wherein the stator has a plurality of magnet coils installed on a stator core
wherein the rotor has a plurality of conductive rotor bars that are electrically coupled to a pair of conductive end plates, wherein the end plates electrically couple the rotor bars to each other, and wherein the rotor includes one or more electrically conductive components, wherein the one or more electrically conductive components include at least one of the rotor bars and end plates.

10. The apparatus of claim 9, wherein the one or more electrically conductive components include each of the rotor bars and each of the end plates.

11. The apparatus of claim 9, wherein at least a portion of the one or more magnet coils is formed by carbon nanotube conductors.

12. The apparatus of claim 9, further comprising a power cable coupled to the motor, wherein the power cable provides power from the drive to the motor, wherein the power cable includes one or more electrical conductors that are formed by carbon nanotube elements.

13. The apparatus of claim 12, wherein the power cable includes one or more carbon nanotube strength members, wherein the strength members support the weight of the cable and the motor.

14. An apparatus comprising:
a downhole electric motor, wherein the motor has a stator that includes a plurality of magnet coils installed on a stator core;
wherein the motor has either a rotor or a mover positioned within the stator, wherein magnetic fields generated by the coils of the stator cause the rotor or mover to move within the stator;
wherein at least a portion of the one or more magnet coils is formed by carbon nanotube conductors.

15. The apparatus of claim 14, wherein the ESP motor comprises an induction motor that has a rotor wherein the rotor includes one or more carbon nanotube conductors.

16. The apparatus of claim 15, wherein the rotor comprises a squirrel-cage type rotor and wherein the carbon nanotube conductors comprise one or more rotor bars of the rotor.

17. The apparatus of claim 16, wherein the carbon nanotube conductors further comprise one or more conductive end plates of the rotor, wherein the end plates electrically couple the rotor bars to each other.

18. The apparatus of claim 15, further comprising a power cable coupled to the motor, wherein the power cable provides power from the drive to the motor, wherein the power cable includes one or more electrical conductors that are formed by carbon nanotube elements.

19. The apparatus of claim 18, wherein the power cable includes one or more carbon nanotube strength members, wherein the strength members support the weight of the cable and the motor.
